(19) United States
(12) Patent Application Publication
(10) Pub. No.: US 2019/0193480 A1
(43) Pub. Date: Jun. 27, 2019

(54) SENSOR SYSTEM FOR MONITORING TIRE WEAR

(71) Applicant: The Goodyear Tire & Rubber Company, Akron, OH (US)

(72) Inventors: Carl Trevor Ross Pulford, Akron, OH (US); Cheng-Hsiung Lin, Hudson, OH (US)

(21) Appl. No.: 16/225,286

(22) Filed: Dec. 19, 2018

Related U.S. Application Data
(60) Provisional application No. 62/608,358, filed on Dec. 20, 2017.

(51) Int. Cl. B60C 11/24; H01Q 1/22

(52) U.S. Cl. CPC B60C 11/243; G06K 19/0723; H01Q 1/2241; B60C 11/246

(57) ABSTRACT

A tread wear indicator is affixed to a respective tire tread element. The indicator is constructed as a plurality of radially stacked sensor elements operatively configured and located to sequentially sacrificially abrade and change in electrical resistance responsive to a progressive tread wear of the respective tread element. The sensor elements are connected by circuitry that communicates a data signal from the sensor elements to a data processor indicative of a change in cumulative resistivity of the sensor elements. The data processor receives the data signal from the sensor elements and determines a radial wear level of the tread element based on the data signal. Multiple tread wear indicators may be mounted to respective tread lugs across the tread to derive a tread wear status based upon the tread wear profiles of the respective lugs.

### FIELD OF THE INVENTION

The invention relates generally to a sensing system for real-time monitoring of tire wear over its life time and, more specifically, to a sensing system based on tire-embedded tread wear sensor implementation.

### BACKGROUND OF THE INVENTION

The use of tread wear indicators is not new and the use of tread wear indicators is mandated by law in many countries. A variety of such indicators are known. Once such type employs colored indicia below the tread for a visual indicator of wear. Other types use tie-bar type elements in the tread grooves.

The practical problem with the colored indicators of the type mentioned is that, being visual, the vehicle operator has to manually inspect each tire on the vehicle while it is stationary in order to find the colored indicators on the tire circumference, which is slow and inconvenient it is also difficult to do in muddy, dirty or snowy conditions. Similar problems occur when the tire employs the tie-bar type wear indicator and it can be difficult to determine the extent of wear until the tire is completely worn. It is quicker and easier for the operator to use the visual Lincolns head penny coin method.

U.S. Pat. No. 6,523,586 discloses wear indicators for a tire tread wherein, in a series, or predetermined closely located grouping, of related marks, the marks disappear as the tire is worn. While this provides continuous information to the consumer, the complexity of forming the tire is increased due to the need to form multiple different marks that appear only after a defined amount of wear. While providing information about the extent of wear to the vehicle operator, this visual type of wear indicator suffers from the same practical operational problems mentioned above in [003]. Furthermore, the measurement is not numerical or digital so in order to derive full information from it, such as the rate of wear, the results must be transcribed into a computer or smart phone. This is slow and inconvenient for the operator.

A cheap and effective tread wear indicator which is readily integrated into a tire and which reliably measures tread wear in a manner easily monitored by a vehicle operator is, accordingly, desired and heretofore unattained.

### SUMMARY OF THE INVENTION

According to an aspect of the invention, a vehicle tire and tread wear device assembly includes a tread wear indicator affixed to one or more tire tread elements.

### Definitions

“Groove” means an elongated void area in a tread that may extend circumferentially or laterally about the tread in a straight curved, or zigzag manner. Circumferentially and laterally extending grooves sometimes have common portions and may be sub classified as “wide”, “narrow”, or “sipe”. The slot typically is formed by steel blades inserted into a cast or machined mold or tread ring therefor. In the appended drawings, slots are illustrated by single lines because they are so narrow.

A “sipe” is a groove having a width in the range from about 0.2 percent to 0.8 percent of the compensated tread width, whereas a “narrow groove” has a width in the range from about 0.8 percent to 3 percent of the compensated tread width and a “wide groove” has a width greater than 3 percent thereof. The “groove width” is equal to tread surface area occupied by a groove or groove portion, the width of which is in question, divided by the length of such groove or groove portion; thus, the groove width is its average width over its length. Grooves, as well as other voids, reduce the stiffness of tread regions in which they are located. Sipes often are used for this purpose, as are laterally extending narrow or wide grooves. Grooves may be of varying depths in a tire. The depth of a groove may vary around the circumference of the tread, or the depth of one groove may be constant but vary from the depth of another groove in the tire. If such narrow or wide groove are of substantially reduced depth as compared to wide circumferential grooves which they interconnect, they are regarded as forming “tie bars” tending to maintain a rib-like character in the tread region involved.

“Inner” means toward the inside of the tire and “outer” means toward its exterior.

“Outer” means toward the tire's exterior.

“Radial” and “radially” are used to mean directions radially toward or away from the axis of rotation of the tire.

“Tread” means a molded rubber component which, when bonded to a tire casing, includes that portion of the tire that comes into contact with the road when the tire is normally inflated and under normal load. The tread has a depth conventionally measured from the tread surface to the bottom of the deepest groove of the tire.

“Tread Element” is a protruding portion of a tread such as a lug or rib which constitutes the element that comes into contact with the road.

### BRIEF DESCRIPTION OF THE DRAWINGS

The invention will be described by way of example and with reference to the accompanying drawings in which:

FIG. 1 is a perspective view of a tire and tread wear sensor assembly;

FIG. 2 is a close-up front view of a tire and tread wear sensor assembly;

FIGS. 3A-3F are example capacitor electrical elements suitable for use in the invention;

FIG. 4 is a first embodiment of a tread wear sensor;

FIG. 5 is a second embodiment of a tread wear sensor;

FIG. 6 is a schematic diagram of a vehicle having a tire and passive tread wear sensors assembly mounted on each axle that could be powered and communicated wirelessly with a vehicle hub mounted miniature RFID reader with direct power source from the vehicle;

FIG. 7 is a schematic diagram of a vehicle having a tire and passive tread wear sensors assembly mounted on each axle that could be powered and communicated wirelessly with a vehicle hub mounted miniature RFID reader with power source from a wireless charging transmitter that is powered by vehicle;

FIG. 8 is a schematic diagram of a vehicle having a tire and passive tread wear sensors assembly mounted on each axle that could be powered and communicated wirelessly with a single RFID reader with power source from the vehicle;

FIGS. 9A-D illustrate alternate embodiments of capacitive sensors mounted in the tread elements.

### DETAILED DESCRIPTION OF THE INVENTION

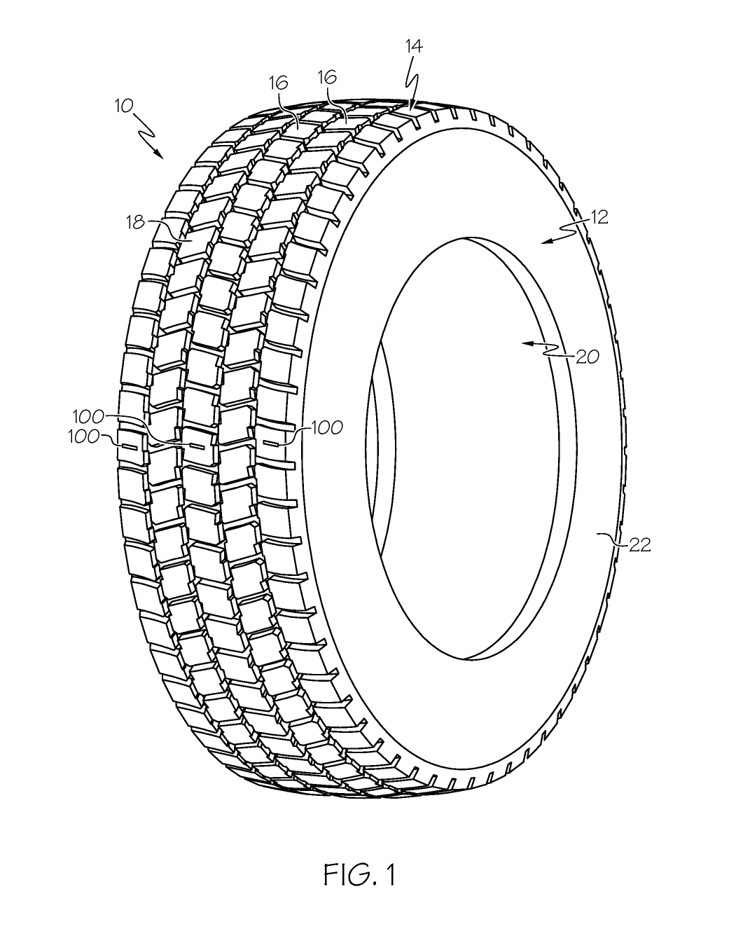

Referring to FIG. 1, an example tire 10 is shown having a sidewall 12 and a radially outward tread 14. The tread 14 as shown may further include one or more tread elements 18, such as for example, multiple rows of tread lugs 16. However, the tread elements 18 may also be tread blocks or tread ribs. However, the invention is not limited to a tread with tread elements 18, and may also be used on a smooth outer tread surface having no tread elements. The tire 10 further includes an inner liner or air impervious layer 20. Pursuant to conventional tire construction, the tire 10 is formed as a tire carcass 22 in a green tire build procedure and subsequently cured into the finished tire product.

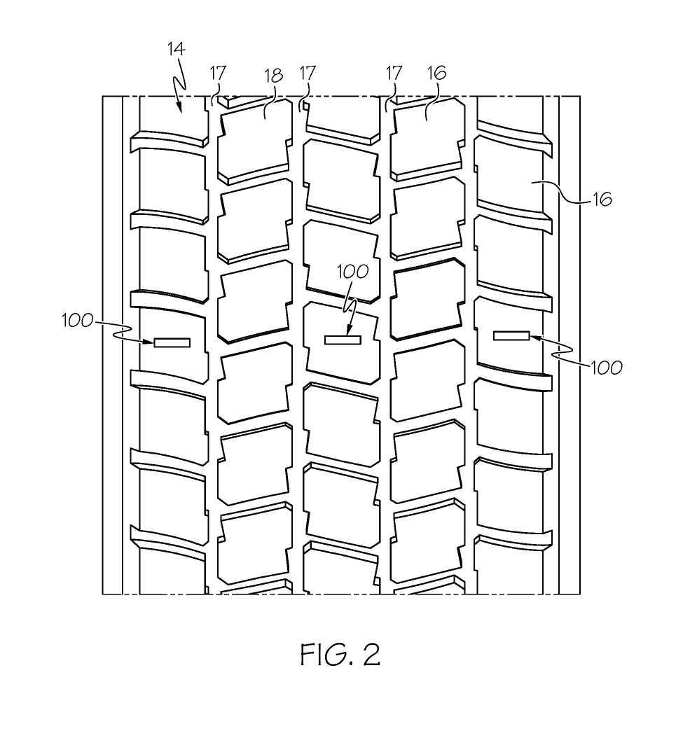

FIG. 2 illustrates an enlarged view of the tread region, illustrating the tread rows 16 formed by the spaced apart tread elements 18 that are separated by circumferential grooves 17. At least one of the tread elements 18, and preferably multiple tread elements, are equipped with a sensor 100, also referred herein as a “wear sensor” or “treadwear indicator.” The purpose of the sensor is to detect the progressive wearing of the tread elements 18 or the depth of a tire tread having no tread elements. One or more of the tread wear sensors 100 are mounted in the tread in order to monitor the general tread wear of the tire. By monitoring tread wear digitally, by a wireless electrical reader, the wear status of the tire and rate of wear may be ascertained. From determining the wear status of the tire, a decision on whether and when to replace the worn tire may be made.

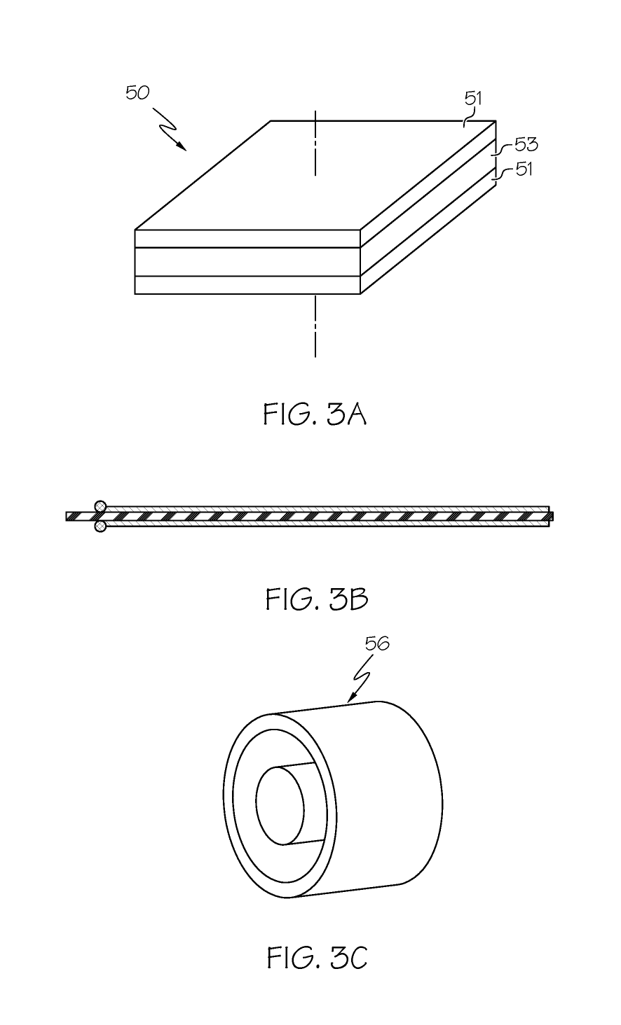

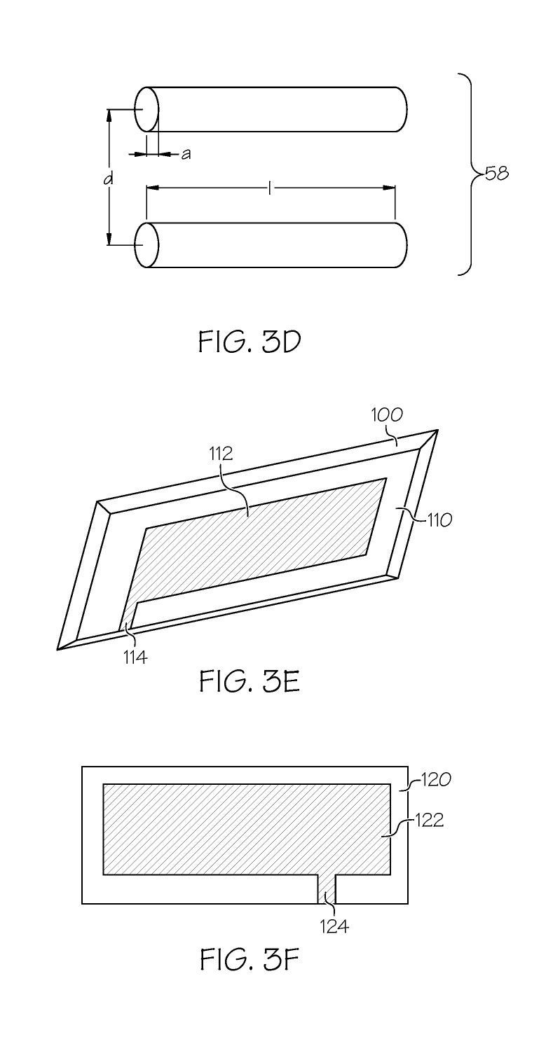

With reference to FIG. 3, the principle by which the tread wear sensors 100 operate will be understood. Each tread wear sensor 100 includes an electrical element that is a capacitor. FIG. 3A illustrates a capacitor made of two opposed conductive plates that are separated by a dielectric. Thus, a thin strip of rubber or polymer 100 that has a first side 110 and a second side 120 that is either painted or printed with a large block 112,122 of electrically conductive paint or ink to form a capacitor, with printed lead lines 114,124. One suitable ink for use in a tire is made by EMS, Inc in Delaware, Ohio and is sold under the trade name CI-2061. The ink must also be electrically conductive and flexible, and be capable of withstanding more than 50% strain both dynamic and static. In one example, the type of ink that would work is graphite ink.

Other examples of capacitors are shown in FIG. 3C a coaxial cable and pair of parallel wires as shown in FIG. 3D.

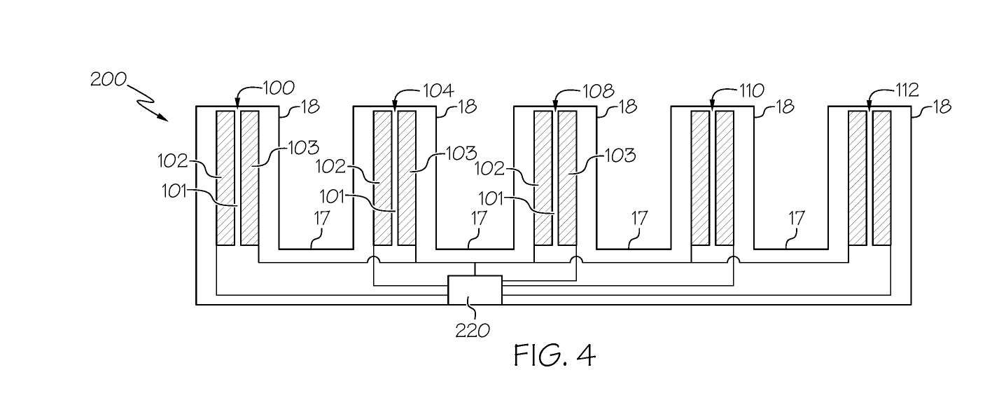

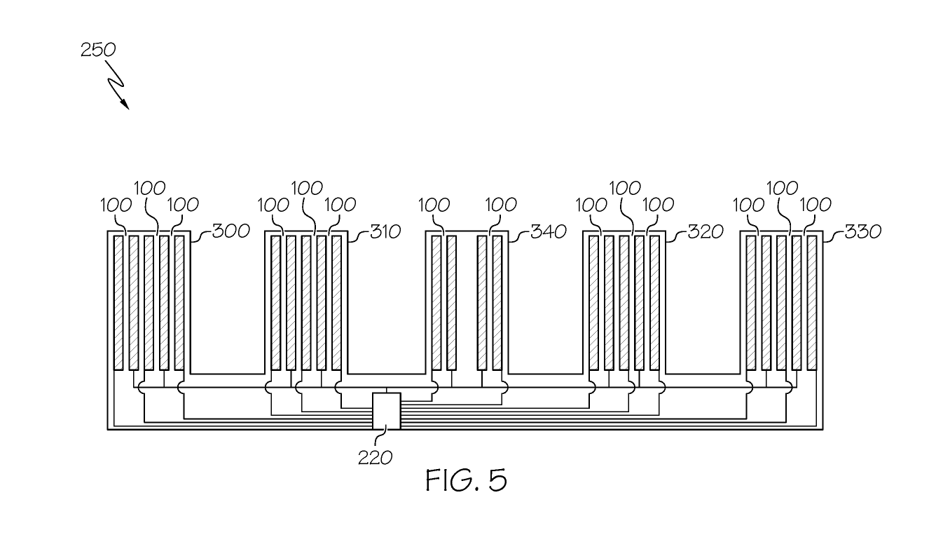

FIG. 4 illustrates a first example of a tread wear sensor system 200. The tread wear sensor includes a plurality of sensors 100 embedded in the tread elements of a tire. One or more of the tread elements have a sensor 100 that utilizes a capacitive sensor. The sensor 100 includes a rubber layer (dielectric layer) having a first conductive plate A on a first side, and a second conductive plate B on a second side. The first and second conductive plates with dielectric layer act as a capacitor. The capacitance signal indicates the remaining tread depth. Preferably, conductive ink is used to print desired area on each side of the rubber layer 100 as shown in FIG. 3E and FIG. 3F based on the required initial capacitance level that will be determined by detection sensitivity and signal noise. The capacitor configuration is not limited to a parallel-plate capacitor. Several other capacitor configurations such as coaxial, pair of parallel wires, or to parallel coplanar strips could also be used for this purpose and are shown in FIGS. 3C and FIG. 3D. This type of sensor is a continuous tread wear indicator. The measured capacitance C_{T} has linear relationship with remained tread depth L as C_{T}=C_{O} X L/L_{O}

The capacitance sensor is oriented in the radial direction so that as the tread wears, the capacitance level decreases. Preferably, each of the capacitance sensors are printed or painted with electrically conductive and flexible ink, and then inserted in a sipe or groove of the tire. Alternatively, the sensors could be mounted to an outer surface of the tread block or rib.

More preferably, multiple capacitance sensors electrically connected to single chip RFID tag 220 to provide rib based or location based wear indication and converter chip to provide A/D conversion. The RFID tag 220 is enhanced to receive multiple data inputs. FIG. 4 is one of one example to provide rib based wear information (5 ribs tire);

FIG. 5 is a second embodiment of a sensor system that is similar to the embodiment shown in FIG. 4, except for the following differences. Each tread element includes multiple capacitive sensors 100. For example, tread elements 300,310,320 and 330 each have at least one capacitance sensor, preferably at least two capacitance sensors 100 and more preferably at least three capacitance sensors 100. The tread element 340 has at least one capacitance sensor, and preferably two capacitance sensors. The capacitance sensors are in electrical communication with a passive RFID tag that preferably includes an Analog/digital converter chip.

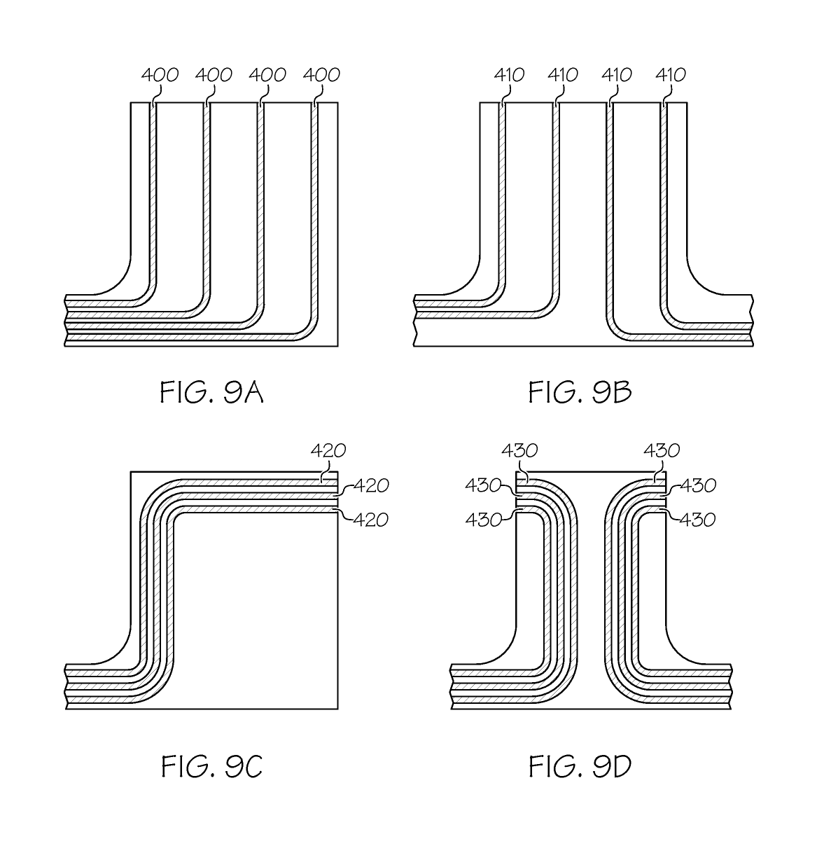

FIG. 9 illustrates additional configurations of capacitance sensors arranged in tread elements. FIG. 9A illustrates capacitance sensors for an axially outer tread element with sensors arranged for discrete tread wear detection. FIG. 9b illustrates capacitance sensors for an axially interior tread element with sensors arranged for discrete tread wear detection. FIG. 9C illustrates capacitance sensors for an axially outer tread element with sensors arranged for continuous tread wear detection. FIG. 9D illustrates capacitance sensors for an axially interior tread element with sensors arranged for continuous tread wear detection.

Furthermore, one or more of the capacitor based sensors 100 could also be used as aquaplaning detector. As the tire runs through the wet surface, the circuit will indicate near zero capacitance (shorted). This may provide extra safety information for vehicle operation.

As examples from the above described embodiments, the enhanced passive tag will integrate with at least one (may include multi-channels) A/D converter that provides power from RFID tag to sensor and converts measured signal (analog) into digital form and store it to RFID tag's memory that then transmitted to RFID reader upon requested as illustrated in FIGS. 11 and 12. Multiple A/D converters may be used if different types of sensors (for example, voltage and capacitance based sensor) are integrated with same RFID tag;

### Reader Location and Power Options

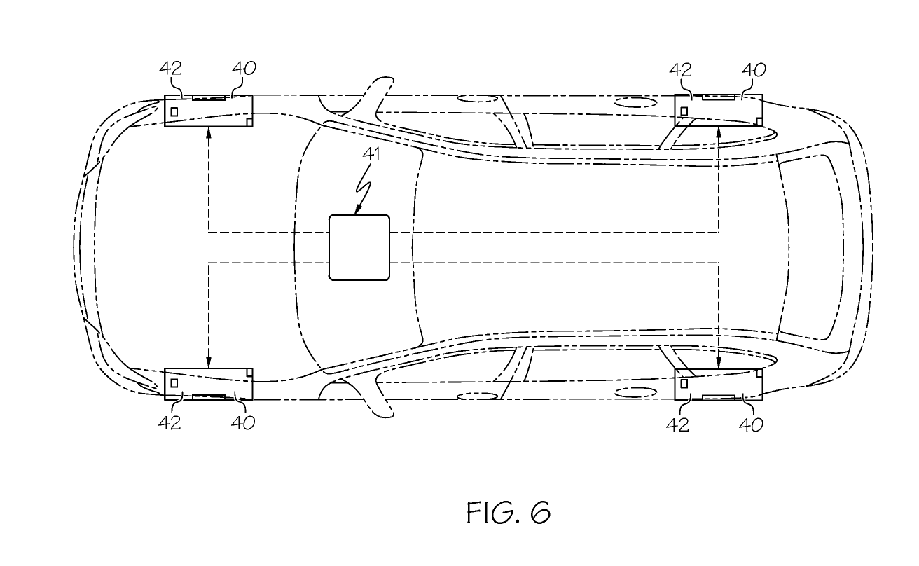

Each reader 40 may be a small electronic receiver, electronic transceiver that could communicate with a passive RFID (RadioFrequency IDentification) tag/sensor to obtained required information; In another embodiment as shown in FIG. 6, there are four miniature readers 40 located at each vehicle axle, wherein the readers 40 are mounted to a protected wheel hub. Each miniature reader 40 is preferably included a mid- or long-range wireless power receiver 42 so that it would be powered wirelessly by a central vehicle mid- or long-range wireless charging transmitter 41. The wireless charging transmitter 41 is powered by the vehicle battery and wirelessly charges each miniature reader 40 via the power receiver 42. A rechargeable battery or supercapacitor base power storage device is preferably included with reader 40. A low power RF reader could be implemented for this application as the reader is closed to sensors. A programable RFID reader is preferably for this application that could handle multiple tag/sensors in a tire without any hardware modification. Multiple wireless communication protocols are preferably included within the reader such as Bluetooth, Wi-Fi and/or LTE.

An alternative embodiment is shown in FIG. 8 wherein there is a single RFID reader 60 that is mounted in the vehicle and is powerful enough to read the signals from the sensors. the reader 60 receives power from the vehicle battery.

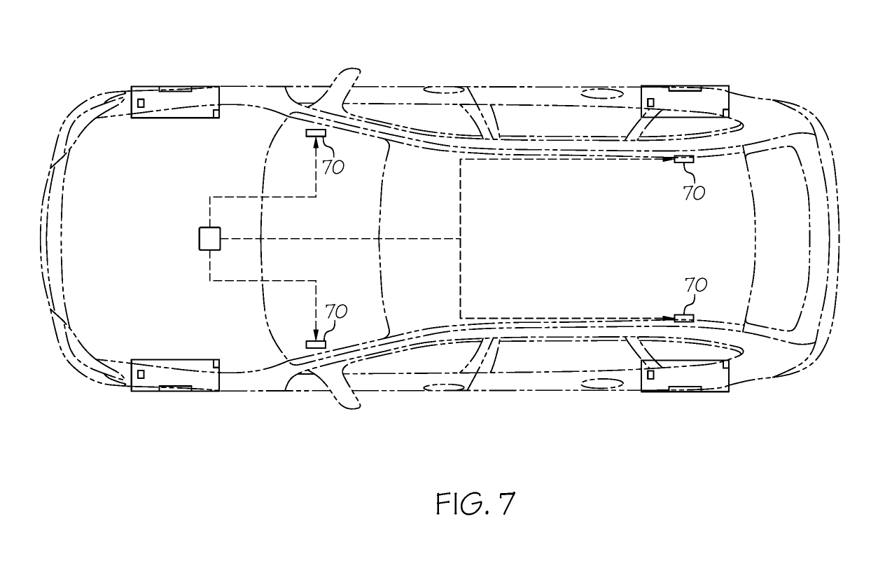

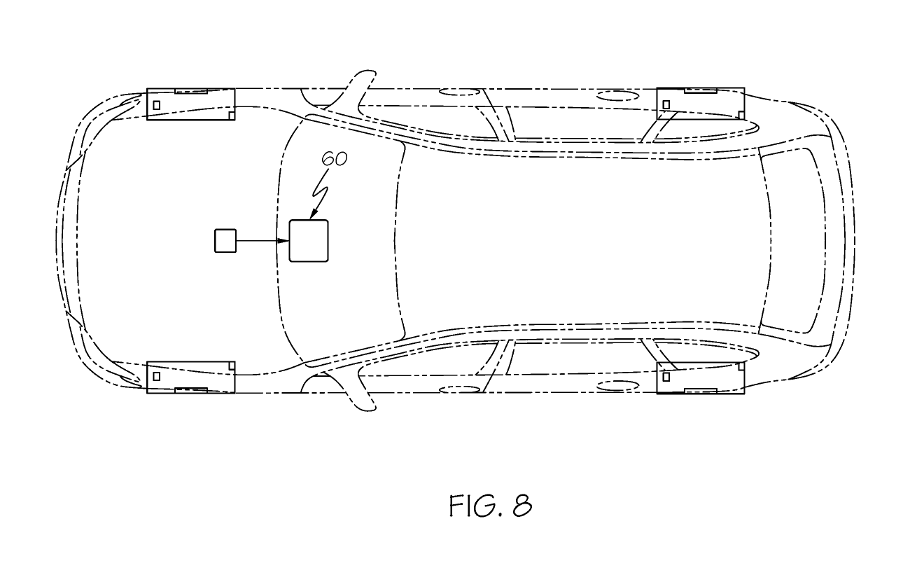

In an alternate embodiment, the reader is at a remote location such as a drive over reader device. Alternatively, the reader may be powered by a small battery or energy harvestor embedded in the patch, or be hardwired to the vehicle battery as shown in FIG. 7.

The tread depth measurement would only need to be taken at low frequency and transmitted infrequently e.g., once a month due to the slow wear rate of tires, so power requirements would be low. The tread depth readings could be stored on a server for commercial tire management & data analysis. For consumer tires, the server could send emails to consumer warning of need to replace a worn-out tire. In addition, the non-skid of all four tires on a passenger car could be monitored as well as say both shoulders of each to give info on alignment maintenance. This convenience would be even more valuable on commercial fleet vehicles where the non-skid of all 18 wheels could be monitored automatically.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A vehicle tire and tread wear sensor comprising:
a tire having a tread; and
a tread wear sensor mounted in the tread, said tread wear sensor comprising a thin layer having a first and second outer surface each having a capacitor formed of conductive ink, wherein the tread wear sensor is positioned in a groove or sipe of the tread, wherein the printed circuit is in electrical communication with a RFID tag.

2. The vehicle tire and tread wear sensor of claim 1 wherein the thin layer is rubber.

3. The vehicle tire and tread wear sensor of claim 1 wherein the capacitor is oriented in the radial direction of the tread.

4. The vehicle tire and tread wear sensor of claim 1 wherein the circuit is printed using a stretchable ink.

5. The vehicle tire and tread wear sensor of claim 1 wherein the RFID tag is printed on the thin layer of rubber, and is in electrical communication with the printed circuit.

6. The vehicle tire and tread wear sensor of claim 1 wherein the RFID tag is a chip mounted on the thin layer.

7. The vehicle tire and tread wear sensor of claim 1 wherein the RFID tag is a chip mounted on the tread in a groove.

8. The vehicle tire and tread wear sensor of claim 3 wherein the RFID tag is a chip mounted on the tread in a pocket of a groove.

9. The vehicle tire and tread wear sensor of claim 1 wherein the tread wear sensor is mounted in the tread in a sipe post cure of the tire.

10. The vehicle tire and tread wear sensor of claim 1 further comprising a reader.

11. The vehicle tire and tread wear sensor of claim 1 further comprising data processing means for determining a tread wear status of the tread based on the absence of an electrical signal from the electrical element.

12. The vehicle tire and tread wear sensor of claim 1 wherein the RFID tag is passive.

13. The vehicle tire and tread wear sensor of claim 1 wherein the RFID tag has a A/D convertor.

14. A vehicle tire and tread wear sensor comprising:
a tire having a tread;
a tread wear sensor comprising at least one electrical element affixed to a rubber layer, wherein the rubber layer is mounted in the tread, wherein the electrical element is made of a capacitor for emitting an electrical signal; and
a passive circuit mounted in electrical communication with the electrical element and capable of sensing the electrical signal emitted from the electrical element.

15. The vehicle tire and tread wear sensor of claim 14 wherein the electrical element is sacrificial.

16. The vehicle tire and tread wear sensor of claim 14 wherein there is an array of capacitor sensors mounted in the tread.

17. The vehicle tire and tread wear sensor of claim 14 wherein the passive voltage-measuring circuit is mounted in the tread in a groove.

18. The vehicle tire and tread wear sensor of claim 14 wherein the sensor is mounted to the side of a tread element.

19. The vehicle tire and tread wear sensor of claim 14 wherein the reader is a UHF-RFID reader.

20. The vehicle tire and tread wear sensor of claim 14 wherein the reader is a passive UHF-RFID reader.

21. The vehicle tire and tread wear sensor of claim 14 wherein the RFID tag is mounted in the tire.

22. The vehicle tire and tread wear sensor of claim 14 wherein the tire is mounted upon a wheel, and the RFID reader is mounted on the wheel.

23. The vehicle tire and tread wear sensor of claim 14 further comprising data processing means for determining a tread wear status of the tread based on the electrical signal from the tread wear sensors.
